(19) United States
(12) Patent Application Publication
(10) Pub. No.: US 2004/0095480 A1
(43) Pub. Date: May 20, 2004

(54) System and method for providing help with operating an image capture device

(76) Inventors: Amy E. Battles, Windsor, CO (US); Miles Thorland, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/300,502

(22) Filed: Nov. 20, 2002

(51) Int. Cl. H04N 5/76

(52) U.S. Cl. 348/231.9

(57) ABSTRACT

A system and method for providing help with operating an image capture device is provided. One embodiment comprises a method for providing help with operating an image capture device. The method comprises providing via an interface of the image capture device a menu comprising at least one menu option; providing a sub-menu in response to a selection of one of the menu options, wherein the sub-menu comprises a help option and at least one sub-menu option, the at least one sub-menu option relating to the selected menu option; and providing information regarding at least one of the at least one sub-menu option in response to a selection of the help option.

### FIELD OF THE INVENTION

The present application relates generally to image capture devices, and in particular to a system and method for providing help with operating an image capture device.

### DESCRIPTION OF RELATED ART

Image capture devices, such as cameras, camcorders, scanning devices, and the like, often include a plethora of features and options, a majority of which may not be familiar to the novice user and, in some instances, the experienced user. To aid users in the operation of image capture devices, image capture device manufacturers, distributors, and/or the like typically provide manuals and/or other printed instructions regarding the operation of the image capture devices to users. However, a user does often not have these instructions available when attempting to operate the image capture device, which leaves the user without help at the time when the user typically needs it the most. Moreover, even when the user does have the instructions, it is cumbersome for the user to try to simultaneously review the instructions and operate the image capture device.

### BRIEF SUMMARY OF THE INVENTION

The present invention is directed to a system and method for providing help with operating an image capture device. One embodiment comprises a method for providing help with operating an image capture device. The method comprises providing via an interface of the image capture device a menu comprising at least one menu option; providing a sub-menu in response to a selection of one of the at least one menu option, wherein the sub-menu comprises a help option and at least one sub-menu option, the at least one sub-menu option relating to the selected menu option; and providing information regarding at least one of the at least one sub-menu option in response to selection of the help option.

### BRIEF DESCRIPTION OF THE DRAWINGS

FIG. 1 illustrates exemplary components of an image capture device in accordance with an embodiment of the invention;

FIG. 2 is an exterior view of an image capture device in accordance with an embodiment of the invention;

FIG. 3A is a menu of an exemplary user interface in accordance with an embodiment of the invention;

FIG. 3B is a sub-menu of the exemplary user interface of FIG. 3A in accordance with an embodiment of the invention;

FIG. 3C illustrates information that may be provided by the exemplary user interface of FIGS. 3A and 3B;

FIG. 3D illustrates information that may be provided to the user in other embodiments of the interface shown in FIGS. 3A and 3B;

FIG. 4 is an alternative menu of an exemplary user interface in accordance with an embodiment of the invention; and

FIG. 5 is a flow diagram for an exemplary method of providing help with operating an image capture device in accordance with an embodiment of the invention.

### DETAILED DESCRIPTION

FIG. 1 illustrates exemplary components of an image capture device in accordance with an embodiment of the invention. Image capture device 100 may be in part any image capture device now known or later developed. Non-limiting examples of such image capture devices include digital cameras, digital camcorders, scanning devices, and/or the like. Although the term “image” is used throughout this disclosure, a person skilled in the art will realize that the present invention may be applied to any image-centric multimedia object. This image-centric multimedia object may also contain sound, a series of images that represent a clip of digital video, or animated graphics. Attributes such as these may be depicted by graphical overlays on the image.

In the illustrated embodiment, image capture device 100 comprises a lens 160 operable to direct light reflected from an object scene onto an image sensor 110. In some embodiments, the light passes through a known shutter and aperture mechanism (not shown) before striking sensor 110. This shutter and aperture mechanism may be activated by a push button or similar user control of buttons 150 (described in greater detail below).

Sensor 110 may be any sensor now known or later developed that is operable to generate image data in response to light impacting thereupon. It will be appreciated that sensor 110 may comprise a plurality of such sensors. A non-limiting example of the above-described sensors is a single array charge coupled device (CCD) sensor covered by a color filter array, although other devices (MOS, CMOS, charge injection, etc.) may be used as well. Furthermore, sensor 110 may comprise a plurality of CCD sensors with appropriate filter/mirrors (not shown) provided to direct particular colors onto specific sensors. For example, three CCD sensors may be used to detect red, green, and blue light respectively.

In addition to or in the alternative of the above, image capture device 100 may comprise memory media 130. Memory media 130 may be any storage medium, now known or later developed, operable to store information. Non-limiting examples of such storage media include optical, magnetic, and solid state memory devices (e.g., RAM, ROM, etc.). Furthermore, memory media 130 may comprise a plurality of such storage media. In some embodiments, at least a portion of memory media 130 is removable (e.g., flash cards and the like). However, in an alternative embodiment, all of memory media 130 is integrated with image capture device 100.

Image data may reside in memory media 130. Such image data may comprise the earlier-discussed image data generated by sensor 110 or data generated, at least in part, therefrom. For example, data resulting from conversion of and/or other processing of the data generated by sensor 110.

Furthermore, memory media 130 may have information other than image data stored therein. For example, memory media 130 may have residing thereon code, instructions, data, etc., for providing an interface, such as a graphical user interface (GUI), for image capture device 100. Furthermore, memory 130 may comprise code, instructions, data, etc., for enabling other operations, aspects, settings, features, etc. of image capture device 100 described herein. The operations, etc., of image capture device 100 described herein may exist as a running process or service on image capture device 100. When such running processes or services are implemented via executable instructions, various features of image capture device 100 are in essence the code defining the operations of such various features. These processes, etc., may be implemented in any code, now known or later developed, to include C, C++, Visual Basic, Java, any CORBA-integrated language, etc.

In the illustrated embodiment, image capture device 100 comprises processor portion 120. Processor portion 120 may be communicatively coupled to memory 130, as well as other components of image capture device 100, via bus 170. Processor portion 120 may comprise any processor now known or later developed. Furthermore, processor portion 120 may comprise any hardware and/or software needed to perform the operations, etc., of image capture device 100 described herein. It will be appreciated that processor portion 120 may comprise more than one processor.

In one embodiment, processor portion 120 is operable to store at memory media 130 image data generated, at least in part, via sensor 110. In addition or in the alternative, processor section 120 is operable to retrieve image data stored at memory media 130 and provide such image data to display device 140 so as to produce an image thereon.

Display device 140 may be any device, now known or later developed, operable to display an image (e.g., an electronic image). For instance, display device 140 may be a liquid crystal (LCD) display, a cathode ray tube (CRT) display, light emitting diode (LED) display or organic LED (OLED) display, and/or the like. Display device 140 may be mounted on and/or within image capture device 100. It will be appreciated that display device 140 may comprise more than one device operable to display an image (e.g., a microdisplay and an LCD image display).

In addition to or in the alternative of the above, processor portion 120 may be operable to retrieve and process the earlier-discussed code that may be stored at memory media 130. For example, processor portion 120 may be operable to provide the earlier-discussed interface using, at least in part, code stored at memory media 130. This interface may be presented by processor portion 120 to a user through display device 140. Furthermore, processor portion 120 may be operable to process the above-discussed code that may be stored at memory media 130 for one or more of the other operations of image capture device 100 described herein.

Furthermore, processor portion 120 may use inputs from buttons 150 to direct and/or influence operations performed thereby. As a non-limiting example, processor portion 120 may use inputs from buttons 150 to determine which information to provide a user via the aforementioned interface. Likewise, processor portion 120 may use inputs from buttons 150 to determine which image or images to present via display device 140. Buttons 150 may comprise any apparatus, now known or later developed, that may receive input from a human operator and transform such into a signal that can be provided to processor section 120, memory 130, and/or other components of device 100. Non-limiting examples of such control devices include discrete buttons, force sensors, rotatable elements (e.g., thumbwheels, dials and the like), toggles, levers, switches, etc.

It will be appreciated by one of ordinary skill in the art that the components of image capture device 100 depicted in FIG. 1, as well as the arrangement thereof, are by way of example only. Image capture device 100 may comprise fewer, more, and/or different elements than those depicted in FIG. 1. For example, image capture device 100 may comprise one or more components of existing image capture devices. Non-limiting examples of such components include a power source (e.g., a battery), image processing circuitry operable to process image data generated by sensor 110 prior to storage or viewing of the data (e.g., an analog signal processor, an analog-to-digital converter, a digital signal processor, etc.), and a communications adapter for receiving and/or communicating data to another device (e.g., a computer, monitor, printer, etc.) and/or data network (e.g., a local area network, a wide area network, a metropolitan area network, the Internet). Similarly, the components of image capture device 100 may be arranged in a different manner than that depicted in FIG. 1. For example, portions of the depicted components may be included as part of other components. For instance, one or more of buttons 150 may be part of display device 140 (e.g., a touch sensitive area on display device 140 or a control area of display device 140 that may be triggered by pointing-and-clicking on the control area).

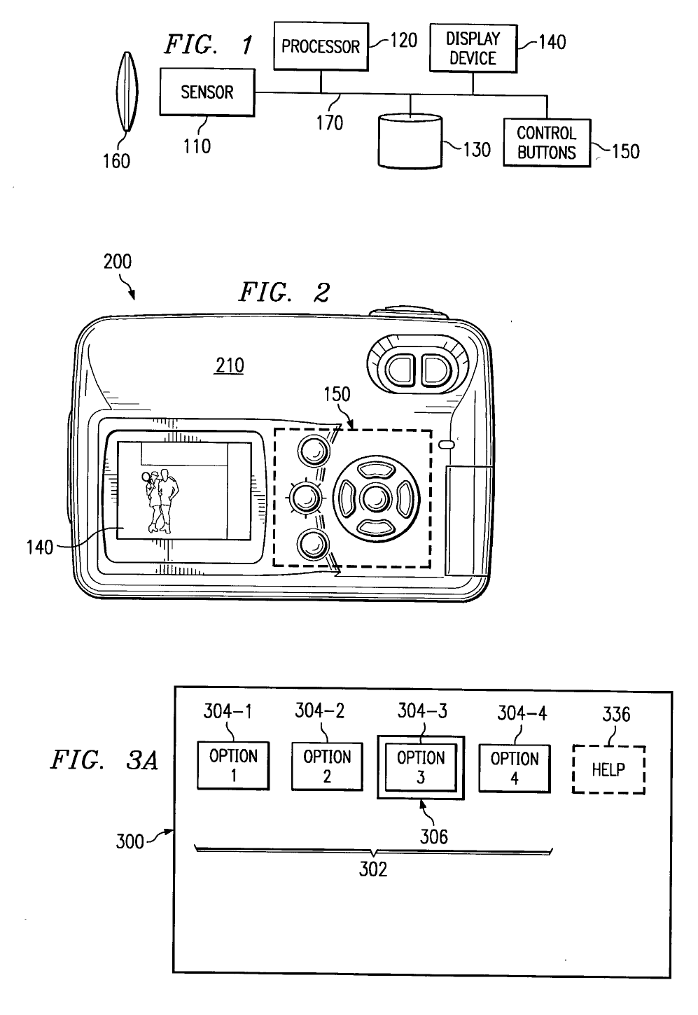

The components of image capture device 100 shown in FIG. 1, as well as other components, may be mounted on and/or within a single housing. FIG. 2 is an exterior view of an image capture device in accordance with an embodiment of the invention. In particular, FIG. 2 shows a surface 210 of housing 200 that supports at least a portion of display device 140. Surface 210 (and/or other portions of housing 200) may also support one or more of buttons 150 (e.g., one or more buttons, rotating elements, switches, soft controls, etc.). In one embodiment, one or more of these controls may be used by a user of image capture device 100 to interact with the earlier-discussed interface provided by image capture device 100.

It will be appreciated that the embodiments of housing 200, display device 140, and buttons 150 depicted in FIG. 2 are by way of example only. Housing 200, display device 140, and buttons 150 may have different sizes, shapes, arrangements, etc., than that depicted in FIG. 2. For example, display device 140 may have a smaller area and be located elsewhere on housing 200. Likewise, buttons 150 may have different shapes and sizes, as well be located elsewhere on housing 200, than that depicted in FIG. 2. Similarly, housing 200 may comprise more, fewer, and/or different elements than those depicted in FIG. 2. For example, surface 210 and/or other portions of housing 200 may comprise a hand grip, an optical view finder, and/or other components of existing image capture devices.

As mentioned, image capture device 100 may present an interface (e.g., a graphical user interface) to a user thereof. Again, this interface may be presented to a user via display device 140. The interface may be displayed on display device 140 in lieu of a captured image or along with one or more captured images.

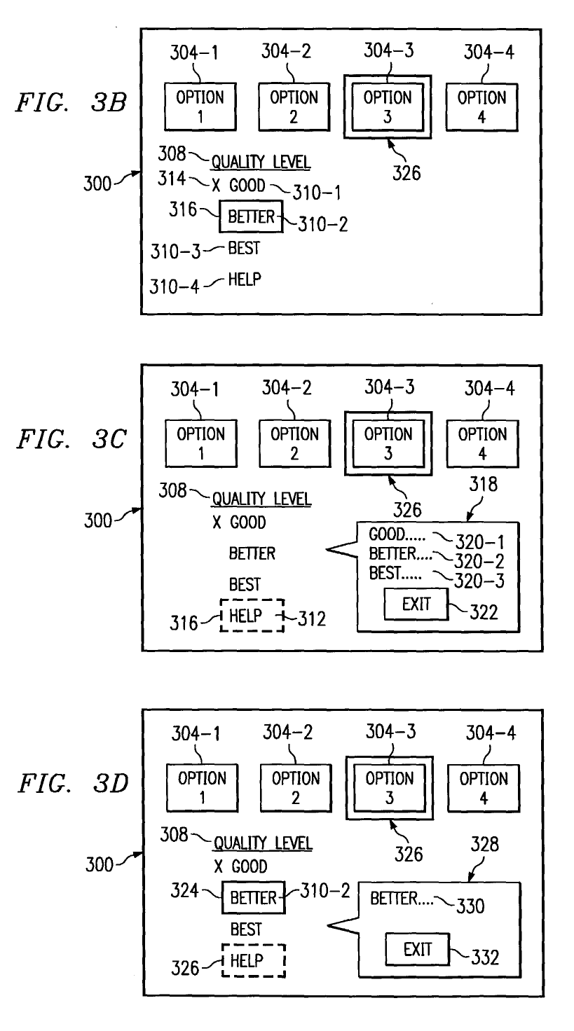

In various embodiments, the interface of image capture device 100 comprises at least one menu. FIG. 3A is a menu of an exemplary user interface in accordance with an embodiment of the invention, and FIG. 3B is a sub-menu of the exemplary user interface of FIG. 3A in accordance with an embodiment of the invention. In the embodiment illustrated in FIG. 3A, interface 300 comprises a menu 302. Menu 302 may comprise one or more menu options 304 (e.g., menu options 304-1 to 304-4) that may be selected by a user. A user may select a menu option of menu 302 using any means, now known or later developed, for selecting a feature of an interface (e.g., pointing and clicking, touch screen, etc.). In one embodiment, interface 300 comprises a selection marker 306 that may be used, with the help of buttons 150, to scroll through the various menu options and select or highlight one or more thereof. The menu options of menu 302 may act as links to other menus of interface 300.

Menu 302 may be any menu relating to the operation of an image capture device (e.g., a main menu and/or a settings menu). Likewise, menu options 304 may comprise any available option, now known or later developed, for the operation of an image capture device. Non-limiting examples of such menu options include quality level, resolution, color, brightness, balance, flash, auto focus range, auto exposure metering, focus lock, exposure bracket, shutter speed, saturation, sharpness, contrast, audio capture, exposure compensation, exposure mode, white balance, ISO speed, rotate, thumbnails, setup, print, e-mail, share-to-web, image stamp, text stamp, logo stamp, display, sound, connect mode, date and time, image counter, language, camera name, play settings, slide show, playback rate, video format, edit, transmit, find, delete, protect, categorize, group, file type, and the like.

FIG. 3B depicts user interface 300 after a selection of a menu option of menu 302 by a user. In the illustrated embodiment, menu option 304-3 has been selected. In one embodiment, to indicate such, selection marker 306 is replaced with selection indicator 326.

Selection of a particular menu option of menu 302 may result in the provision of a sub-menu (e.g. sub-menu 308). In one embodiment, such a sub-menu comprises a help option (e.g., help option 310-4) and at least one sub-menu option (e.g., sub-menu options 310). The sub-menu options may relate to the selected menu option.

It will be understood that help options may be available for any menu list or submenu list. For example, in one embodiment, top-level menu 302 also includes help option 336.

As a non-limiting example of the above, in the illustrated embodiment, menu option 304-3 comprises a “quality level” setting option. The sub-menu options of sub-menu 308 provided in response to the selection of option 304-3 may therefore relate to a “quality level” setting for image capture device 100. In one embodiment, sub-menu option 310-1 is associated with a “GOOD” setting, sub-menu option 310-2 with a “BETTER” setting, and sub-menu 310-3 with a “BEST” setting.

Similar to the menu options, with the help of buttons 150, a user may navigate through the quality-level options 310-1 to 310-3 and help option 310-4 and may select one or more thereof. In one embodiment, user interface 300 comprises a selection marker 316 that indicates (e.g., by highlighting, bolding, circling, underlining, backlighting, or the like) the current option being considered by the user for selection. In one embodiment, user interface 300 may comprise a selection indicator 314 (such as the “X” in FIG. 3B) that indicates the user's previous selection, which may correspond to the current setting of image capture device 100.

In some embodiments, selection of one or more of sub-menu options sets image capture device to a particular setting. For example, in FIG. 3B, by selecting sub-menu option 310-1, the user sets image capture device 100 to the “GOOD” setting. The same may be true for the selection of one or more of menu options 304.

In the illustrated embodiment, selection of help option 310-4 results in the provision of information regarding at least one of sub-menu options 310. Thus, at least some of the information provided in response to the selection of help option 310-4 is context-specific. Moreover, the information provided may comprise any information relating to one or more of the sub-menu options. For example, the provided information may comprise a description of one or more of sub-menu options 310. Also, the information may discuss available options for one or more of sub-menu options 310. Furthermore, the information may instruct the user as to how to activate an operational feature of image capture device 100 relating to one or more of sub-menu options 310. In addition, the information may provide recommendations regarding one or more of the sub-menu options. Further still, the information provided may comprise links to other information. In one embodiment, some of the information provided is not specific to sub-menu options 310.

As non-limiting examples of the above, in the embodiment illustrated in FIG. 3B, the information provided in response to a selection of help option 310-4 may teach that the GOOD setting produces lower quality images and uses less memory than the BETTER setting. Moreover, the information may recommend using the GOOD setting for images the user plans to use on a computer, or to print photos of having dimensions of up to 10×15 cm (≈4×6 inches). In addition or in the alternative, the information may disclose that the BETTER setting produces high-quality images and uses less memory then the BEST setting. Furthermore, the information may recommend using the BETTER setting for images the user plans to enlarge and print photos of having dimensions of up to 13×18 cm (≈5×7 inches). Similarly, the information may disclose that the BEST setting produces the highest-quality images and uses the most memory. In addition, the information may recommend that the user use this setting for images the user plans to enlarge and print photos of having dimensions of up to 18×24 cm (≈8 ×10 inches).

The information provided may respectively relate to each of sub-menu options 310. However, in an alternative embodiment, the information provided may be specific to less than all of (e.g., one of) the sub-menu options 310. FIGS. 3C and 3D non-limiting examples of the above-discussed embodiments.

FIG. 3C illustrates information that may be provided by the exemplary user interface of FIGS. 3A and 3B. In FIG. 3C, selection of help option 310-4 results in the provision of information display 318. In one embodiment, information display 318 is provided in lieu of, or overlays, sub-menu 308. In the illustrated embodiment, all of information display 318 and sub-menu 308 is visible to the user. In an alternative embodiment, the help information might appear on a new screen shown on display 140. For example, a help screen might overlay the entire menu or screen from which the help feature was selected.

Also in the illustrated embodiment, information display 318 comprises information pieces 322-1, 322-2, and 322-3 (collectively information pieces 322). In one embodiment, each of information pieces 322 may relate to a particular one of the sub-menu options 320 (e.g., information piece 322-1 relates to sub-menu option 310-1, information piece 322-2 relates to sub-menu option 310-2, and information piece 322-3 relates to information piece 310-3). The information pieces may comprise information of the type described above and/or links to such information. In one embodiment, information display 318 includes an exit option 322, whereby selection thereof returns the user to sub-menu 308 and/or removes information display 318. Sub-menu 308 may also include an exit option (not shown), the selection of which returns the user to menu 302. In one embodiment, if the submenu does not have an exit option, then selecting any menu item except the “Help” option automatically saves the setting and exits the menu.

FIG. 3D illustrates information that may be provided to the user in other embodiments of the interface shown in FIGS. 3A and 3B. In FIG. 3D, selection of help portion 310-4 results in the provision of information display 328. Unlike the earlier-discussed embodiment, the information presented in information display 328 is specific to a particular sub-menu option. In the illustrated embodiment, information display 328 comprises information piece 330, which relates to sub-menu option 310-2. Information piece 330 may comprise information of the type described above and/or links to such information.

In one embodiment, a user selects the sub-menu option to which the information provided by information display 328 is to relate by first selecting help option 310-4. After such, selection indicator 326 denotes the selection of help option 310-4. Simultaneously with or after the appearance of indicator 326, selection means 324 is provided. Through selection means 324, the user may designate the particular sub-men option for which the user desires information. In one embodiment, such designating involves positioning selection means 324 at a particular sub-menu option. As selection means 324 is positioned over different sub-menu options, information relating to the sub-menu option where means 324 is presently positioned appears in information display 328. In some embodiments, further operations are required before the information is provided. For example, the user may have to first click, select, etc., a sub-menu option before information is provided in information display 328.

Information display 328 may be provided in lieu of or overlay sub-menu 308. In the illustrated embodiment, all of information display 328 and sub-menu 308 is visible to the user. In one embodiment, information display 328 comprises an exit option 332, whereby selection thereof returns the user to sub-menu 308 and/or removes information display 328. As mentioned earlier, sub-menu 308 may also include an exit option (not shown), the selection of which returns the user to menu 302.

It will be appreciated that the components of user interface 300 depicted in FIGS. 3A 3B, 3C, and 3D, as well as their arrangement, is by way of example only. User interface 300 may have fewer, more, and/or different components than those depicted in FIGS. 3A and 3B. In addition, the components of user interface 300 may be arranged differently than that depicted in FIGS. 3A, 3B, 3C, and 3D. As a non-limiting example of the above, menu options 304 may be of a different shape and size, as well as a different arrangement, than that depicted in FIGS. 3A-3D. Likewise, sub-menu 308 may include more, fewer, and/or different options than those depicted in FIGS. 3A-3D. Sub-menu 308 may also be of a different sizes, shapes, and/or arrangement than that depicted in FIGS. 3A-3D. In one embodiment, submenu 308 is on a different screen separate from the main menu.

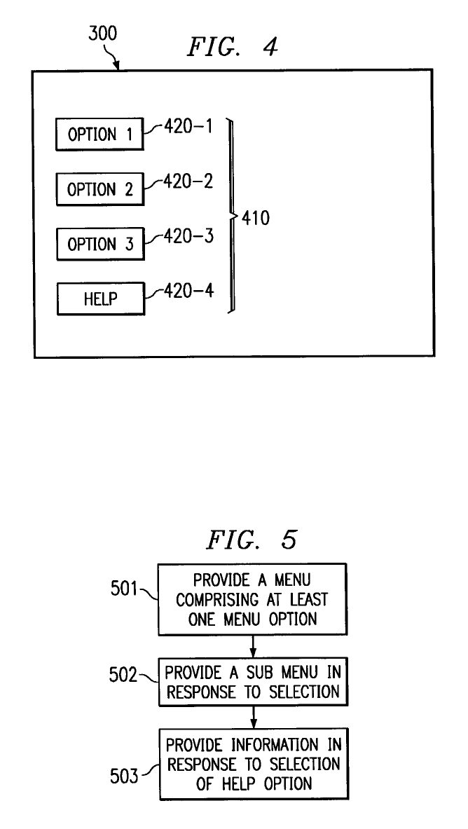

As another non-limiting example of the above, in some embodiments, menu 302 is provided in response to a selection of a menu option of another menu. FIG. 4 depicts an embodiment of such a menu. FIG. 4 is an alternative menu of an exemplary user interface in accordance with an embodiment of the invention. In FIG. 4, user interface 300 also comprises menu-410. In one embodiment, menu 410 comprises one or more menu options 420 (e.g., menu option 420-1 to 420-3 and Help option 420-4). Menu 402 may be any menu relating to the operation of an image capture device (e.g., a main menu and/or a submenu). Likewise, menu options 420 may comprise any available option, now known or later developed, for the operation of an image capture device. In one embodiment, menu 402 also comprises help option 420-4. In the illustrated embodiment, menu 302 is provided in response to selection of option 420-3.

As discussed above, one or more menus of user interface 300 may comprise a help option. In some embodiments, a help option is provided for each sub-menu of user interface 300. However, doing such may require a significant amount of memory. In order to reduce the amount of memory used when providing the above-discussed help with operating image capture device 100, in one embodiment, a help option is not provided for those menus where the options of such menus are intuitive or would be familiar to the user. Non-limiting examples of such menus include certain image deletion option menus or flash setting option menus. However, help options may be provided for less familiar menus, such as PC connection, video format, etc.

FIG. 5 is a flow diagram for an exemplary method of providing help with operating an image capture device in accordance with an embodiment of the invention. FIG. 5 provides a flow diagram depicting exemplary steps of a method for providing help with operating image capture device 100. In one embodiment, the image capture device provides menu 302 via interface 300 (step 501). As mentioned, menu 302 may comprise at least one menu option 304. In one embodiment, menu 302 includes “Help” option. After one of the menu options of menu 302 is selected by a user, image capture device 100 provides sub-menu 308 (step 502). Furthermore, after a user selects help option 310-4 from the sub-menu, the image capture device provides information regarding at least one of the sub-menu options (step 503).

What is claimed is:

1. A method for providing help with operating an image capture device, said method comprising:
providing, to a user via an interface on said image capture device, a menu comprising at least one menu option;
providing a sub-menu in response to a selection of one of said at least one menu option, wherein said sub-menu comprises a help option and at least one sub-menu option, said at least one sub-menu option relating to said selected menu option; and
providing information regarding at least one of said at least one sub-menu option in response to a selection of said help option.

2. The method of claim 1 wherein said menu further comprises a help option.

3. The method of claim 1 further comprising
providing said menu in response to a selection of a menu option of another menu.

4. The method of claim 3 wherein said another menu further comprises a help option.

5. The method of claim 1 wherein said menu comprises a settings menu.

6. The method of claim 1 wherein said at least one menu option comprises at least one menu option selected from the group consisting of quality level, resolution, color, brightness, balance, flash, auto focus range, auto exposure metering, focus lock, exposure bracket, shutter speed, saturation, sharpness, contrast, audio capture, exposure compensation, exposure mode, white balance, ISO speed, rotate, thumbnails, setup, print, e-mail, share-to-web, image stamp, text stamp, logo stamp, display, sound, connect mode, date and time, image counter, language, camera name, play settings, slide show, playback rate, video format, edit, transmit, find, delete, protect, categorize, group, and file type.

7. The method of claim 1 wherein said information is specific to one of said at least one sub-menu option.

8. The method of claim 1 wherein said information relates respectively to each of said at least one sub-menu option.

9. The method of claim I wherein said image capture device comprises a digital camera.

10. The method of claim 1 further comprising
providing said interface via display device of said image capture device, said display device being mounted on or within a housing of said image capture device.

11. A system for providing help with operating an image capture device, said system comprising
at least one memory medium; and p1 a processor portion communicatively coupled to said at least one memory medium; p1 wherein said processor portion is operable to provide an interface comprising a menu that comprises at least one menu option; p1 wherein said processor portion is further operable to provide a sub-menu in response to a selection of one of said menu options, said sub-menu comprising a help option and at least one sub-menu option, said at least one sub-menu option relating to said selected menu option; and p1 wherein said processor portion is further operable to provide information regarding at least one of said at least one sub-menu option in response to a selection of said help option.

12. The system of claim 11 wherein said processor portion is further operable to provide said menu in response to a selection of a menu option of another menu.

13. The system of claim 12 wherein said another menu further comprises a help option.

14. The system of claim 11 wherein said menu comprises a settings menu.

15. The system of claim 11 wherein said information is specific to one of said at least one sub-menu option.

16. The system of claim 11 wherein said processor portion provides said interface at least in part via a display device of said image capture device, said display device being mounted on or within a housing of said image capture device.

17. A system for providing help with operating an image capture device, said system comprising
means for providing a menu comprising at least one menu option via a user interface of said image capture device; p1 means for providing a sub-menu in response to a selection of one of said menu options, said sub-menu comprising a help option and at least one sub-menu option, said at least one sub-menu option relating to said selected menu option; and p1 means for providing information regarding at least one of said at least one sub-menu option in response to a selection of said help option.

18. The system of claim 17 further comprising
means for providing said menu in response to a selection of a menu option of another menu.

19. The system of claim 18 wherein said another menu further comprises a help option.

20. The system of claim 17 wherein said menu comprises a settings menu.
